(19) United States
(12) Patent Application Publication
(10) Pub. No.: US 2009/0315422 A1
(43) Pub. Date: Dec. 24, 2009

(54) Rotor of Permanent Magnet Motor

(76) Inventor: Yu-Ta Tu, Taipei City (TW)

Correspondence Address: David Shung, P.O. Box 10557, Taipei, 100, TW

(21) Appl. No.: 12/485,960

(22) Filed: Jun. 17, 2009

(30) Foreign Application Priority Data
Jun. 20, 2008 (TW) 097210902

(51) Int. Cl. H02K 1/28

(52) U.S. Cl. 310/156.12

(57) ABSTRACT

A rotor of permanent magnet motor is disclosed. The rotor includes a fixing seat having a central hole, a shaft penetrating the central hole for driving an external device by magnetic induction, a plurality of magnets annularly disposed on a cylindrical peripheral of the fixing seat, and a plurality of magnet spacers, each of which is disposed between two adjacent magnets. By changing magnetic circuit resulting from the magnet spacers, the magnetic resistance can be reduced because the rotary magnetic field between the magnets and the stator varies. Thus performance of the motor using the rotor of the invention can be improved.

### BACKGROUND OF THE INVENTION

1. Technical Field

The invention relates to electric motors, particularly to permanent magnet motors.

2. Related Art

In modern industries, power machines for providing rotary power are usually necessary. An electric motor is a device using electrical energy to produce mechanical energy. Motors are a common power source employed in many fields such as industrial fans, blowers and pumps, machine tools, household appliances, power tools, and computer disk drives, among many other applications. In general, a motor is composed of a rotor and a stator. The rotor is driven to rotate by the interaction of magnetic fields and current-carrying conductors. Motors whose rotors and stators adopt pernament magnets for providing magnetic fields are called pernament magnet motors. Because the pernament magnet motors can output a considerably high torque in a limited bulk and can provide very great performance and accuracy, they play an important role in the market.

FIG. 1 shows a prior-art rotor 1 of pernament magnet motor, in which N-pole magnets 10 and S-pole magnets 11 are continuously arranged. When the rotor 1 is induced to rotate, a magnetic resistance will rise between the stator and the junctions of the N-pole magnets 10 and S-pole magnets 11 because of a magnetic circuit effect. That will reduce performance of the motor.

### SUMMARY OF THE INVENTION

An object of the invention is to improve performance of a motor by reducing magnetic resistance between a stator and a rotor due to a new arrangement of magnets of the rotor.

To accomplish the above object, the rotor of the invention includes a fixing seat having a central hole, a shaft penetrating the central hole for driving an external device by magnetic induction, a plurality of magnets annularly disposed on a cylindrical peripheral of the fixing seat, and a plurality of magnet spacers, each of which is disposed between two adjacent magnets.

By changing magnetic circuit resulting from the magnet spacers, the magnetic resistance can be reduced. Thus performance of the motor using the rotor of the invention can be improved. Besides, any one of the magnet spacers can be individually replaced because the magnet spacers are individually mounted on the fixing seat

### BRIEF DESCRIPTION OF THE DRAWINGS

A preferred embodiment of the present invention will now be described, by way of example only and not in any limitative sense, with reference to the accompanying drawings in which:

FIG. 1 depicts a polarity distribution status of magnets of a conventional rotor;

FIG. 2 depicts a polarity distribution status of magnets of the invention; and

FIG. 3 depicts a perspective view of the rotor of the invention.

### DETAILED DESCRIPTION OF THE INVENTION

The invention utilizes a special arrangement of magnets to make the magnetic circuit of the magnets so that the magnetic resistance can be effectively reduced.

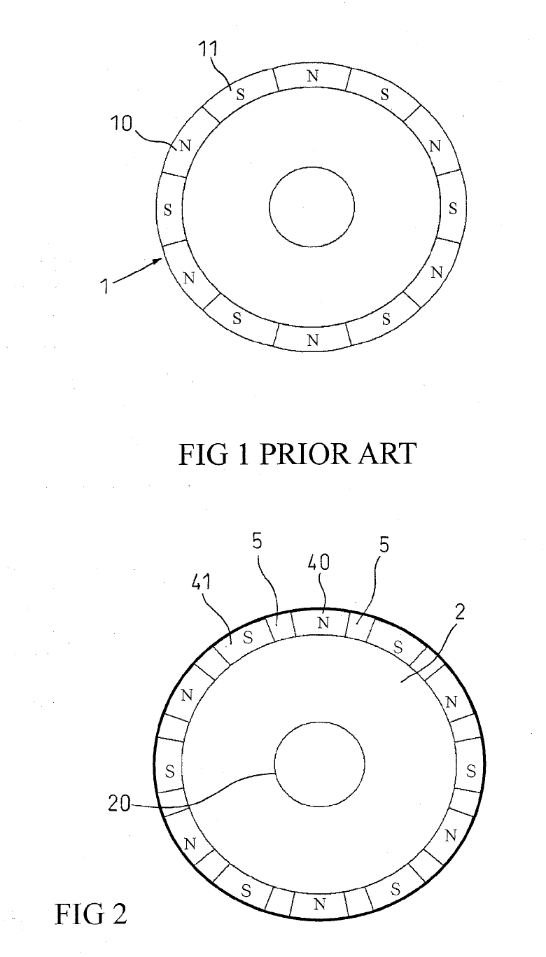

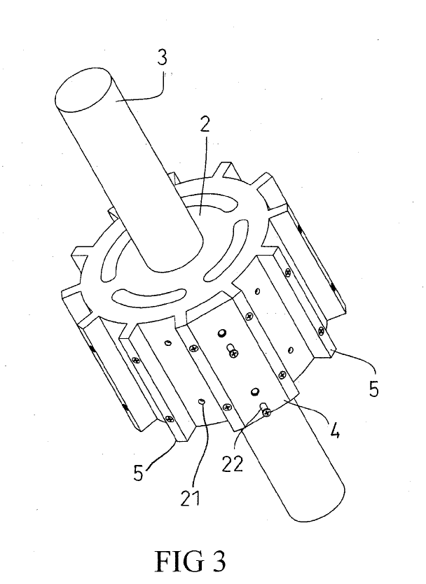

Referring to FIGS. 2 and 3, the rotor of the invention includes:

a fixing seat 2 having a central hole 20 in an axial direction,

a shaft 3 penetrating the central hole 20 of the fixing seat 2 for driving an external device (not shown) by magnetic induction,

a plurality of magnets 40, 41 annularly disposed on a cylindrical peripheral of the fixing seat 2 for generating a magnetic induction with a stator (not shown), and

a plurality of magnet spacers 5, each of which is disposed between two adjacent magnets 40, 41, and which are individually mounted on the fixing seat 2.

The fixing seat 2 is a substantial cylinder, whose surface is provided with securing holes 21 on predetermined positions of the magnets 40, so that the magnets 40 can be secured in the securing holes 21 of the fixing seat 2.

By above arrangement, the magnet spacers 5 will generate a pair of weak magnetic poles because the magnet spacers 5 space out an N-pole magnet 40 and an S-pole magnet 41. That will reduce magnetic resistance between the stator and rotor.

Furthermore, the magnets 40, 41 can positioned more easily than ever because of the existence of the magnet spacers 5. It is advantageous for assembling process. And the magnets 40, 41 do not need to be made very precisely. Besides, the magnets 40, 41 can be individually replaced if one of them fails. Thus it is economical.

It will be appreciated by persons skilled in the art that the above embodiment has been described by way of example only and not in any limitative sense, and that various alterations and modifications are possible without departure from the scope of the invention as defined by the appended claims.

What is claimed is:

1. A rotor of permanent magnet motor, comprising:
a fixing seat having a central hole;
a shaft penetrating the central hole for driving an external device by magnetic induction;
a plurality of magnets annularly disposed on a peripheral of the fixing seat; and
a plurality of magnet spacers, each of which is disposed between two adjacent magnets.

2. The rotor of permanent magnet motor of claim 1, wherein the fixing seat is a substantial cylinder, whose cylindrical surface is provided with securing holes for securing the magnets with fasteners.

3. The rotor of permanent magnet motor of claim 1, wherein the magnet spacers are individually mounted on the fixing seat.
